(19) United States
(12) Patent Application Publication
(10) Pub. No.: US 2005/0121281 A1
(43) Pub. Date: Jun. 9, 2005

(54) Dual clutch

(75) Inventors: Andreas Orlamunder, Schweinfurt (DE); Sebastian Vogt, Bad Neustadt (DE)

Correspondence Address: COHEN, PONTANI, LIEBERMAN & PAVANE, 551 FIFTH AVENUE, SUITE 1210, NEW YORK, NY, 10176, US

(73) Assignee: ZF Sachs AG

(21) Appl. No.: 11/037,611

(22) Filed: Jan. 18, 2005

Related U.S. Application Data
(63) Continuation of application No. 10/648,875, filed on Aug. 27, 2003.

(30) Foreign Application Priority Data
Aug. 28, 2002 (DE) 102 39 404.0

(51) Int. Cl. F16D 21/02

(52) U.S. Cl. 192/48.91; 192/70.16

(57) ABSTRACT

A dual clutch comprises two clutch areas, each with a pressure plate which can be moved by a force-exerting arrangement toward an abutment arrangement, where the abutment arrangement is to be connected by a connecting plate arrangement to a drive element, also comprising a starter gear ring connected to the abutment arrangement for rotation in common, where the starter gear ring has a first connecting area for connection to the abutment arrangement and a second connecting area for connection to the connecting plate arrangement.

### CROSS REFERENCE TO RELATED APPLICATIONS

This application is a continuation of U.S. application Ser. No. 10/648,875, filed Aug. 27, 2003, now pending, the priority of which is claimed under 35 U.S.C. §120.

### BACKGROUND OF THE INVENTION

1. Field of the Invention

The present invention pertains to a dual clutch comprising two clutch areas, each with a pressure plate which can be moved by a force-exerting arrangement toward an abutment arrangement, where the abutment arrangement is to be connected by a connecting plate arrangement to a drive element, and also comprising a starter gear ring connected to the abutment arrangement for rotation in common.

2. Description of the Related Art

In clutches of this type, it is known that the starter gear ring can be connected to the abutment plate arrangement by welding. This connecting process leads to the problem that, as a result of the production of a weld, across which the torque for starting the engine must also be transmitted, a considerable amount of thermal energy is introduced into the abutment arrangement, and this heat can cause local deformations of the part of the arrangement, which will later become frictionally active. This type of connection also requires components of complicated design and leads to problems caused by the centrifugal force that develops when the clutch is operating.

### SUMMARY OF THE INVENTION

It is the task of the present invention to provide a dual clutch with improved functionality in the area of the connection of the gear ring.

According to a first aspect of the present invention, this task is accomplished by a dual clutch comprising two clutch areas, each with a pressure plate which can be moved toward an abutment arrangement by a force-exerting arrangement, where the abutment arrangement is to be connected by a connecting plate arrangement to a drive element, and also comprising a starter gear ring connected to the abutment arrangement for rotation in common, where the starter gear ring has a first connecting area for connection to the abutment arrangement and a second connecting area for connection to the connecting plate arrangement.

In this design, the starter gear ring simultaneously serves the function of a connecting element, by means of which a connection to a drive shaft or the like can be produced.

It is possible, for example, for the connecting area of the starter gear ring to surround the abutment arrangement and to be attached to it by a press fit and/or by welding.

To make it even easier to attach the dual clutch to a drive shaft, it is proposed that the second connecting area of the starter gear ring be axially offset from the gear teeth.

According to another aspect, the task indicated above is accomplished by a dual clutch comprising two connecting areas, each with a pressure plate which can be moved toward an abutment arrangement by a force-exerting arrangement, where the abutment arrangement is to be connected by a connecting plate arrangement to a drive element, also comprising a starter gear ring connected to the abutment arrangement for rotation in common, where the connecting plate arrangement is permanently connected to the abutment arrangement and the starter gear ring is supported on the connecting plate arrangement.

In this embodiment, there is no direct physical contact between the starter gear ring and the abutment arrangement, which means that the problems associated with the connection of the gear ring to the abutment arrangement can be almost completely avoided.

For example, it is possible for the abutment arrangement to be permanently connected to the connecting plate arrangement by screws. Alternatively, the connecting plate arrangement is permanently connected to the abutment arrangement by a press fit and/or by welding.

The connecting plate arrangement can have a connecting ring, which is permanently connected to the abutment arrangement, and the starter gear ring can be supported on the connecting ring.

So that a permanent connection between the connecting ring and the abutment arrangement can be produced easily, it is proposed that the connecting ring be arranged to surround the abutment arrangement and to be connected to it by a press fit. It is then also possible for the starter gear ring to be arranged to surround the connecting ring and to be connected to it by a press fit.

According to another aspect of the present invention, the invention pertains to a dual clutch comprising two clutch areas, each with a pressure plate which can be moved toward an abutment arrangement by a force-exerting arrangement, where the abutment arrangement is to be connected by a connecting plate arrangement to a drive element, also comprising a starter gear ring connected to the abutment arrangement for rotation in common, where an axial stop formation is provided on the abutment arrangement to define the axial position of the starter gear ring.

By providing an axial stop formation, it is possible to specify the exact position which the starter gear ring is to occupy.

For this purpose it is possible, for example, for the abutment arrangement to have a plurality of connecting projections, which can be used to produce the connection to the connecting plate arrangement and for the axial stop formation to be provided in the area of the connecting projections. In this case, it is possible for the axial stop formation to comprise at least one stop pin, which is inserted into the abutment arrangement.

In an alternative variant, furthermore, the axial stop can be provided on an assembly device (not shown).

The various features of novelty which characterize the invention are pointed out with particularity in the claims annexed to and forming a part of the disclosure. For a better understanding of the invention, its operating advantages, and specific objects attained by its use, reference should be had to the drawing and descriptive matter in which there are illustrated and described preferred embodiments of the invention.

### BRIEF DESCRIPTION OF THE DRAWINGS

FIG. 1 shows a partial longitudinal section through a dual clutch according to the invention;

FIG. 2 shows a view, similar to that of FIG. 1, of a second embodiment of the dual clutch;

FIG. 3 shows a view, similar to that of FIG. 1, of a third embodiment of the dual clutch;

FIG. 4 shows a view, similar to that of FIG. 1, of a fourth embodiment of the dual clutch; and

FIG. 5 is a longitudinal section of the fifth embodiment of the dual clutch.

### DETAILED DESCRIPTION OF THE PRESENTLY PREFERRED EMBODIMENTS

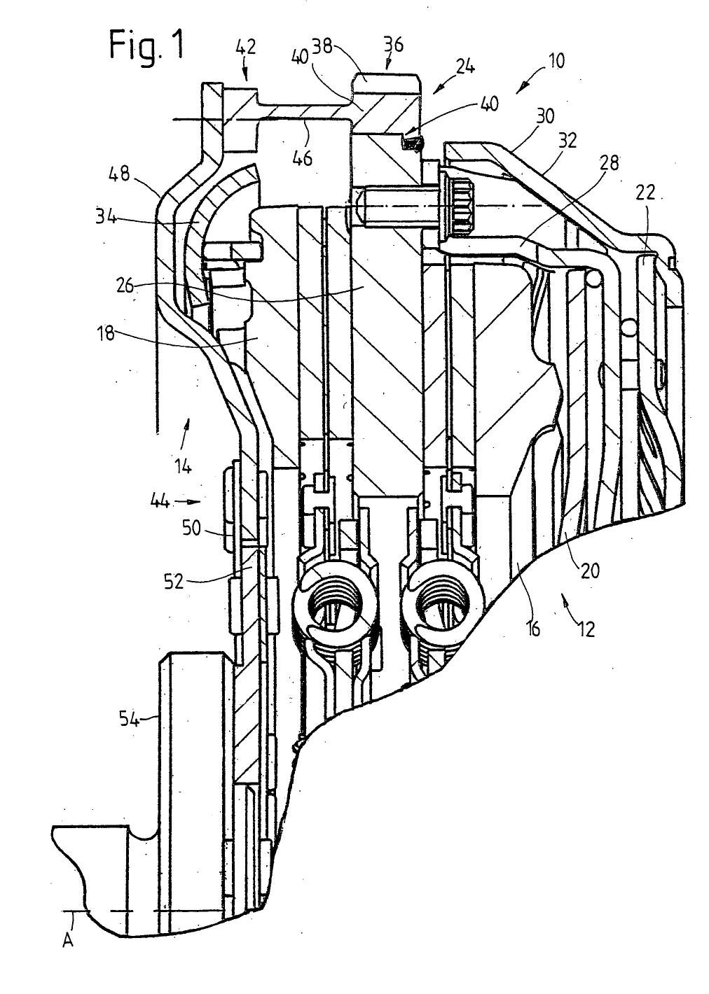

FIG. 1 shows a dual clutch 10 designed in accordance with the principles of the present invention. This clutch comprises essentially two clutch areas 12, 14, each with a pressure plate 16, 18, which can be moved toward an abutment arrangement 24 by the action of a force-exerting arrangement 20, 22. The abutment arrangement 24 in the example shown here comprises an intermediate plate 26, which means that, to engage the two pressure plates 16, 18, they must be moved toward the intermediate plate 26 in opposite axial directions. It is obvious that, if the abutment arrangement 24 were to be designed appropriately with two plate parts, it would also be possible for the two pressure plates 16, 18 to produce a state of engagement by moving in the same axial direction, each one toward the plate part assigned to it. The force-exerting arrangement 20 of the clutch area 12, which can comprise, for example, several engaging force-transmitting lever elements or possibly an energy storage element designed in the form of a diaphragm spring, is supported on a housing 28 so that it can absorb the reaction force; the housing is permanently connected to the intermediate plate 26. The force-exerting arrangement 22 of the clutch area 14 exerts force on the assigned pressure plate 18 by way of a force-transmitting arrangement 30 and is also supported on the housing 28. The force-transmitting arrangement 30 can comprise two cup-like or plate-like force-transmitting elements 32, 34, which are connected to each other and extend across the intermediate plate 26.

In the embodiment shown in FIG. 1, a starter gear ring 36 is designed so that its ring-like area, which also carries the teeth 38, surrounds the abutment arrangement 24; in the example shown here, the ring thus passes radially around the outside surface of the central plate 26. To prescribe a specific axial position, radial shoulders on the intermediate plate 26 and on the starter gear ring 36 can come to rest against each other at 40. The permanent connection of the starter gear ring 36 to the intermediate plate 40 can be accomplished by welding, possibly by laser welding. In principle, however, a press fit can also be used to produce this connection, which can be obtained either by pressing the starter gear ring 36 on or by shrinking it on. In this case, too, at least a few additional connections can be provided around the circumference by welding. The starter gear ring 36, the first connecting area 40 of which is therefore connected to the intermediate plate 26, also has a second connecting area 42, which is axially offset from the area with the teeth 38; in this second area, a connecting plate arrangement, designated 44 overall, is connected to the starter gear ring 36. The second connecting area 42, which can also be designed, for example, in the form of a ring, can be connected to the first connecting area 40 by a connecting web area 46 and can have several internally threaded holes, into which the screw bolts or the like which connect a plate part 48 of the connecting plate arrangement 44 to the starter gear ring 36 are inserted. The plate part 48 is connected by a spring-like formation 50 to an additional plate part 52, which can be permanently connected in turn to a drive shaft 54, such as a crankshaft of an internal combustion engine, by screws or the like. As a result of the elasticity introduced by the formation 50, the wobbling of the drive shaft 54 is disconnected from the dual clutch 10.

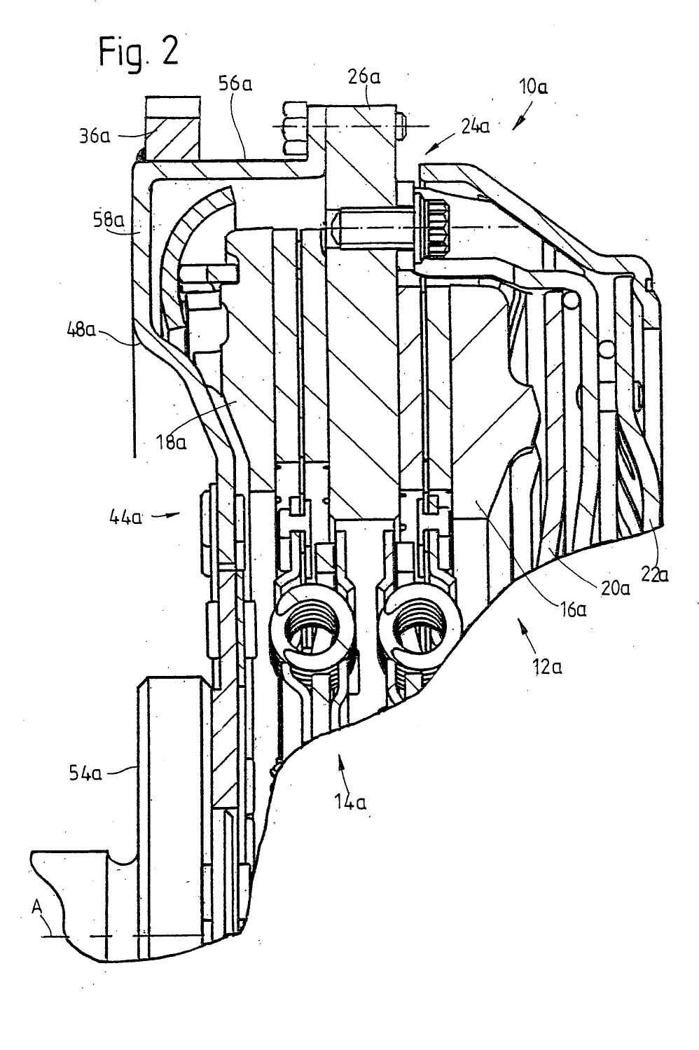

FIG. 2 shows an alternative embodiment of a dual clutch according to the invention. Components which correspond to those described above with respect to design or function are designated by the same reference numbers, to which an “a” has been appended. The design of the dual clutch 10a is basically the same as that described above, so that there is no need to discuss it again.

The plate part 48a of the connecting plate arrangement 44a has a connecting ring 56a in its radially outer area, that is, a ring-like area, which extends more-or-less in the axial direction. At the axial end, at least certain parts of this connecting ring 56a are cranked radially toward the outside, so that the ring-like area can be screwed to the intermediate plate 26a. In the example shown here, the starter gear ring 36a is supported on the connecting ring 56a, preferably on a more-or-less radially oriented section 58a of the plate part 48a at the transition to the axially oriented section, so that a high degree of stability can be achieved. The starter gear ring 36a can be connected by welding, but a press fit is also possible.

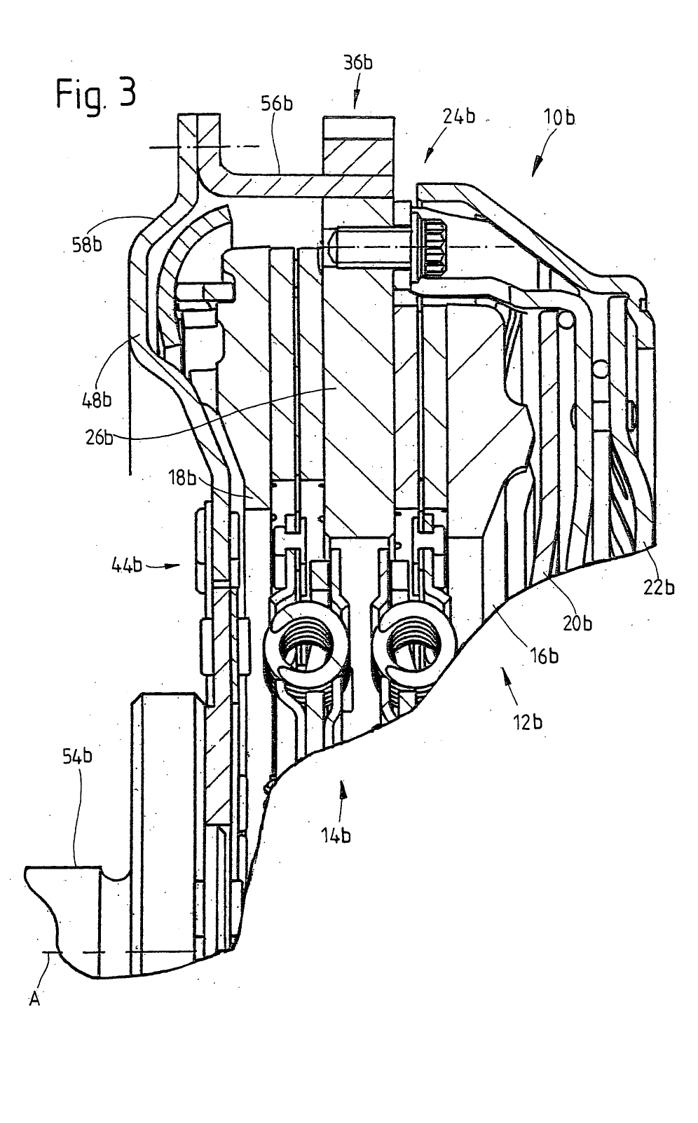

Another embodiment of a dual clutch according to the invention is shown in FIG. 3. Here, too, the basic design is the same as that of the clutch described on the basis of FIG. 1, so that reference can be made to the preceding discussion. Components that correspond to the preceding ones with respect to design and/or function are designated by the same reference numbers, to which a “b” has been appended. It can be seen here that the connecting ring 56b is a part which is separate from the plate part 48b and can be connected permanently by its more-or-less radially oriented area 58b to the plate part by use of screws, rivets, etc. The axially free end area of the connecting ring 56b surrounds the intermediate plate 26b and is connected to it by means of, for example, a press fit. Here, too, the press fit can be accomplished by pushing the one part axially onto the other, by shrinking the one onto the other, etc. The starter gear ring 36b surrounds the connecting ring 56 radially on the outside; that is, it passes around the axial area of the connecting ring by which the connecting ring itself passes radially around the outside surface of the intermediate plate 26b. The starter gear ring 36b is also connected permanently to the connecting ring 56b, preferably by a press fit. Both in the area of the connection between the connecting ring 56b and the intermediate plate 26b and also in the area of the connection between the connecting ring 56b and the starter gear ring 36b, the strength of the joint can be increased by the addition of at least a few welds.

It is obvious that it is also possible in this embodiment for the connecting ring 56b to be designed as an integral part of the plate part 48a of the connecting plate arrangement 44b. In addition, a connection with a positive action in the circumferential direction can also be provided in all of the embodiments:
in the area of the connection between the starter gear ring and, for example, the connecting plate arrangement or the intermediate plate; and also
in the area of the connection between the connecting plate arrangement and the intermediate plate;

This connection can be produced by providing, for example, appropriate projecting and recessed areas, which increase the strength of the connection beyond that provided by the press fit or welding discussed above.

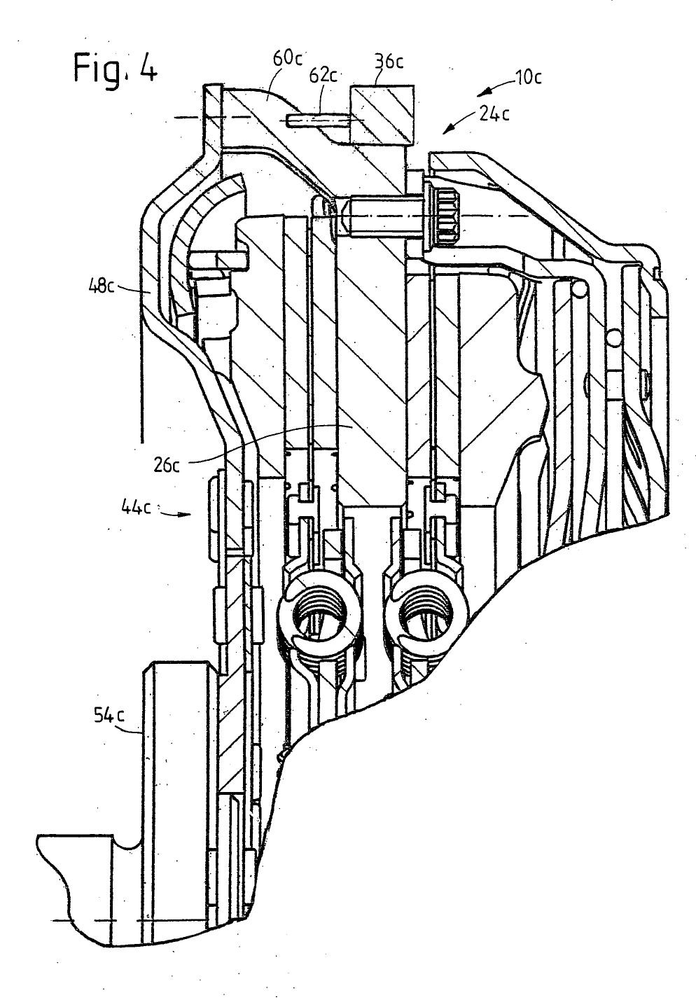

Another embodiment of a dual clutch according to the invention is shown in FIG. 4. Components which correspond to those described above are designated by the same reference numbers, to which a “c” has been appended. In the case of the dual clutch 10c in FIG. 4, the radially outer area of the intermediate plate 26c has a plurality of axially oriented connecting projections 60c. In the area of the free ends of these connecting projections 60c, the plate part 48c of the connecting plate arrangement 44c can be connected by screw bolts or the like to the dual clutch 10c. The starter gear ring 36c surrounds the intermediate plate 26c radially on the outside and is held on it by means of, for example, a press fit or weld and/or by a positive engagement. More-or-less axially oriented stop pins 62c are inserted into at least some of the connecting projections 60c; when the gear ring is pushed axially onto the intermediate plate 26c, the starter gear ring 36c comes to rest against these stop pins. The pins 62c thus form a stop formation for the starter gear ring 36c, which formation specifies the axial position of the ring with respect to the intermediate plate 26c. It is therefore not necessary to provide any notches or the like in the outer circumferential area of the intermediate plate 26c to provide for the appropriate positioning of the starter gear ring. Of course, it is also possible for these pins 62c or corresponding projections or stop surfaces to be provided as an integral component of the connecting projections 60c.

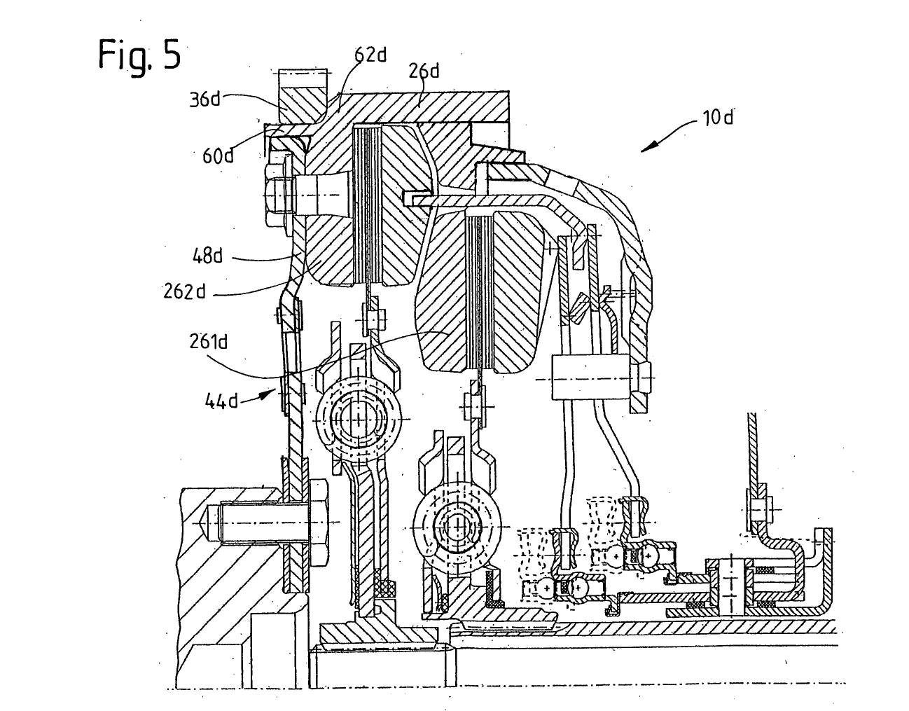

Another embodiment of a dual clutch according to the invention is shown in FIG. 5. Components which correspond to those described above are designated by the same reference numbers, to which a “d” has been appended. In the case of the dual clutch 10d in FIG. 5, the radially outer area of the intermediate plate 26d has a plurality of axially oriented connecting projections 60d. In this design variant, these connecting projections 60d serve to position the connecting plate arrangement 44d with respect to the dual clutch 10d so that their axes are parallel. Alternatively, the connecting projections 60d can be designed as a continuous collar extending in the circumferential direction. It is also disclosed here that, as an alternative, the intermediate plate 26d can consist of two individual intermediate plates 261d and 262d, one of which is assigned to each of the pressure plates. One of the pressure plates is installed with freedom of axial movement between the intermediate plates 261d and 262d. As in FIG. 4, the starter gear ring 36d is positioned in the axial direction by the stop formation 62d, where the pins 62c of FIG. 4 could also be used as an alternative in FIG. 5. Because the connecting projections 60d and the starter gear ring are mounted radially one above the other, the two parts can be made thinner, because each reinforces the other. It should also be noted that the two-part design of the intermediate plate 26d in the form of the two intermediate plates 261d and 262d is also possible as an alternative in the case of the dual clutches described above in association with FIGS. 1-4. The intermediate plate 26 is therefore not in any way to be considered limited to an embodiment as a single intermediate plate located between two pressure plates in any of the embodiments disclosed here.

One advantage of the embodiments described above is that essentially only closed, ring-like components can be used in the area of the connection of the dual clutch to the drive shaft, which significantly reduces the problems caused by centrifugal forces and the stiffness of the components.

The invention is not limited by the embodiments described above which are presented as examples only but can be modified in various ways within the scope of protection defined by the appended patent claims.

1. A dual clutch comprising:
an intermediate plate;
a pair of clutch areas each comprising a pressure plate which can be moved by a force exerting arrangement toward the intermediate plate;
a connecting plate assembly for connecting the intermediate plate to a drive element; and
a starter gear ring having a first connecting area connected to the intermediate plate for rotation in common, and a second connecting area connected to the connecting plate assembly.

2. A dual clutch as in claim 1 wherein the first connecting area surrounds the intermediate plate and is connected to the intermediate plate by at least one of a press fit and welding.

3. A dual clutch as in claim 1 wherein the starter gear ring has gear teeth which are axially offset from the second connecting area.

4. A dual clutch comprising:
an intermediate plate;
a pair of clutch areas each comprising a pressure plate which can be moved by a force exerting arrangement toward the intermediate plate;
a connecting plate assembly for connecting the intermediate plate to a drive element, the connecting plate assembly being directly connected to the intermediate plate; and
a starter gear ring connected to the intermediate plate for rotation in common, the starter ring gear being supported on the connecting plate assembly.

5. A dual clutch as in claim 4 wherein the connecting plate assembly is bolted to the intermediate plate.

6. A dual clutch as in claim 4 wherein the connecting plate assembly is connected to the intermediate plate by at least one of a press fit and welding.

7. A dual clutch as in claim 4 wherein the connecting plate assembly comprises a connecting ring which is directly connected to the intermediate plate, the starter gear ring being supported on the connecting ring.

8. A dual clutch as in claim 7 wherein the connecting ring surrounds the intermediate plate and is connected to the intermediate plate by a press fit.

9. A dual clutch as in claim 7 wherein the starter gear ring surrounds the connecting ring and is connected to the connecting ring in a press fit.

10. A dual clutch comprising:
an intermediate plate having an axial stop formation;
a pair of clutch areas each comprising a pressure plate which can be moved by a force exerting arrangement toward the intermediate plate;
a connecting plate assembly for connecting the intermediate plate to a drive element; and
a starter gear ring connected to the intermediate plate for rotation in common, said starter gear ring being positioned against the axial stop formation.

11. A dual clutch as in claim 10 wherein the intermediate plate comprises a plurality of connecting projections connected to the connecting plate assembly, the axial stop formation being provided on the connecting projections.

12. A dual clutch as in claim 10 wherein the axial stop formation comprises a plurality of axial stop pins.
